(19) United States
(12) Patent Application Publication
(10) Pub. No.: US 2026/0196883 A1
(43) Pub. Date: Jul. 9, 2026

(54) ELECTRIC MOTOR TOPOLOGIES USING RARE EARTH AND/OR RARE EARTH FREE MAGNETS

(71) Applicant: Atieva, Inc., Newark, CA (US)

(72) Inventors: Yuanying Wang, Newark, CA (US); Vivek Meenakshi Sundaram, Newark, CA (US)

(21) Appl. No.: 19/011,066

(22) Filed: Jan. 6, 2025

(51) Int. Cl. H02K 1/02; H02K 1/276

(52) U.S. Cl. CPC H02K 1/02; H02K 1/276

(57) ABSTRACT

An electric motor rotor comprises: a body defining cavities symmetrically arranged about a rotor axis in multiple poles; a rare earth magnet in a radially outermost cavity; and at each of the multiple poles, rare earth free magnets in the cavities inward of the outermost cavity, the rare earth free magnets centered on a radius of the rotor. A rotor for an electric motor comprises: a body defining cavities symmetrically arranged about a rotor axis in multiple poles; and at each of the multiple poles, rare earth free magnets in the cavities, the rare earth free magnets centered on a radius of the rotor, respective widths of the rare earth free magnets perpendicular to the radius of the rotor and tangential to a rotation direction increasing toward the rotor axis, respective thicknesses of the rare earth free magnets along the radius of the rotor decreasing toward the rotor axis.

### TECHNICAL FIELD

This document relates to electric motor topologies using rare earth and/or rare earth free magnets.

### BACKGROUND

Modern vehicles are increasingly designed with one or more electric motors for propulsion. As more advanced motors continue to be developed, key vehicle performance characteristics are taken into account in the design process. One consideration is the cost of the materials of the motor. Another is the efficiency of its operation, because this affects the range that the vehicle can travel given a particular battery size.

### SUMMARY

In a first aspect, a rotor for an electric motor comprises: a body defining cavities, the cavities being symmetrically arranged about a rotor axis in multiple poles; a rare earth magnet in a radially outermost cavity of the cavities of each of the multiple poles; and at each of the multiple poles, rare earth free magnets in the cavities positioned inward of the radially outermost cavity, the rare earth free magnets centered on a radius of the rotor.

Implementations can include any or all of the following features. A shape of the rare earth magnet is essentially a first rectangular prism, and wherein bases of the first rectangular prism are parallel with each other and perpendicular to the radius of the rotor. A shape of each of the rare earth free magnets is essentially a second rectangular prism, and wherein bases of the second rectangular prism are parallel with each other and perpendicular to the radius of the rotor. Respective widths of the rare earth free magnets perpendicular to the radius of the rotor and tangential to a direction of rotation increase toward the rotor axis. Respective thicknesses of the rare earth free magnets along the radius of the rotor increase toward the rotor axis. A width of the rare earth magnet perpendicular to the radius of the rotor and tangential to a direction of rotation is about equal to a width of an uppermost rare earth free magnet of the rare earth free magnets perpendicular to the radius of the rotor and tangential to the direction of rotation. A thickness of the rare earth magnet along the radius of the rotor is less than a thickness of an uppermost rare earth free magnet of the rare earth free magnets along the radius of the rotor. Each pole of the rotor includes the rare earth magnet and three of the rare earth free magnets. All of the rare earth free magnets are made of a common magnetic material.

In a second aspect, a rotor for an electric motor comprises: a body defining cavities, the cavities being symmetrically arranged about a rotor axis in multiple poles; and at each of the multiple poles, rare earth free magnets in the cavities, the rare earth free magnets centered on a radius of the rotor, wherein respective widths of the rare earth free magnets perpendicular to the radius of the rotor and tangential to a direction of rotation increase toward the rotor axis, and wherein respective thicknesses of the rare earth free magnets along the radius of the rotor decrease toward the rotor axis.

Implementations can include any or all of the following features. A shape of each of the rare earth free magnets is essentially a second rectangular prism, and wherein bases of the second rectangular prism are parallel with each other and perpendicular to the radius of the rotor. Each pole of the rotor includes four rare earth free magnets. All of the rare earth free magnets are made of a common magnetic material. The rotor does not include any rare earth magnet.

### BRIEF DESCRIPTION OF DRAWINGS

FIG. 1 shows an example of a motor topology that can be used for one pole of a rotor in an electric motor.

FIG. 2 shows another example of a motor topology that can be used for one pole of a rotor in an electric motor.

Like reference symbols in the various drawings indicate like elements.

### DETAILED DESCRIPTION

This document describes examples of systems and techniques that improve electrical motors using rare earth (RE) and/or rare earth free (REF) permanent magnets. The present subject matter can address shortcomings associated with using other types of electric motors, including but not limited to those that use only RE or only REF magnets. In doing so, lower manufacturing costs and/or higher motor efficiency can be obtained without compromising torque and power performance. In some implementations, the main aim can be to maximize motor capability (i.e., peak torque and power) while avoiding one of the main drawbacks of REF magnets compared to RE magnets, namely demagnetization at lower external magnetic fields.

As used herein, REF permanent magnets are alloys composed of ferro-magnetic materials that do not include RE elements or that at most include an insignificant amount (e.g., a trace amount) of RE elements. The most commonly available REF magnets are ferrite magnets, and other examples include, but are not limited to, iron nitride magnets and manganese bismuth magnets (MnBi magnets). Compared to RE magnets, REF magnets have lower remanence and lower coercivity. Remanence is a measure of the strength of the magnet and coercivity is a measure of the resistance of the magnet to demagnetization at a particular temperature and demagnetizing external magnetic field. Most REF magnets also show different temperature-BH characteristics than most RE magnets, meaning how their magnetic flux density (referred to as the B field) variations with external magnetic field strength (referred to as the H field) are affected by temperature. Motors designed using REF magnets are less expensive compared with motors with RE magnets. However, the volume of the magnetic material in an REF magnet motor must be larger than in a RE magnet motor to meet similar torque and power requirements. REF magnets are also prone to demagnetization at nominal and lower temperatures and/or in the presence of lower external magnetic fields compared to RE (e.g., neodymium) magnets. This in turn limits the motor's power and torque capability.

As used herein, RE permanent magnets are alloys that include at least one RE element, where the RE elements consist of the lanthanides, scandium and yttrium. Examples of RE magnets include, but are not limited to, neodymium magnets (NdFeB magnets) and samarium-cobalt magnets (SmCo magnets). RE elements are difficult to extract and mine and the RE magnets are therefore expensive. RE materials also suffer from significant price fluctuations due to their limited worldwide supply and growing demand which affects their availability and affordability. Motors designed with neodymium magnets offer high torque and power density and efficiency which are critical characteristics for EV applications.

Transportation Electrification, including electric vehicles present unique challenges for motor design. With electric vehicles the demand for torque density in the motor is typically higher than in other motor applications. As a result, electric vehicles are often requested to push as much current as possible through the motor, which may not be common in other fields. Other applications for electric motors typically have significantly lower demagnetization fields than electric vehicles.

Any of at least two different approaches provided by the present disclosure can be applied to improve the design of a permanent-magnet motor. In a first approach, a combination of RE and REF magnets can be used. The resulting electric motor can be referred to as a reduced RE motor. A magnet arrangement can have a small sized RE (e.g., neodymium) magnet positioned close to the air gap of the motor and oriented to shield the REF magnets from demagnetizing fields of the stator. Torque production in this arrangement is primarily from the magnetization of the REF magnets. For example, the REF magnets in this topology can account for a significant share (e.g., about 80-90%) of the total permanent-magnet volume in the motor. This allows for a substantially lower use of RE material compared to an all-RE magnet motor. Hence the motor cost can be significantly reduced with almost same peak power and torque.

In a second approach, the motor includes only REF magnets and no RE magnets. The REF magnets can have varying thickness and width and can be arranged so that they withstand the worst case demagnetizing magnetic field during motor operation. Such a topology can produce power and torque comparable to that of an RE motor at the same overall size. While the total volume of PM material in this approach may be higher than a conventional RE magnet motor, the cost is still lower due to the significantly lower price of REF magnets.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons.

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

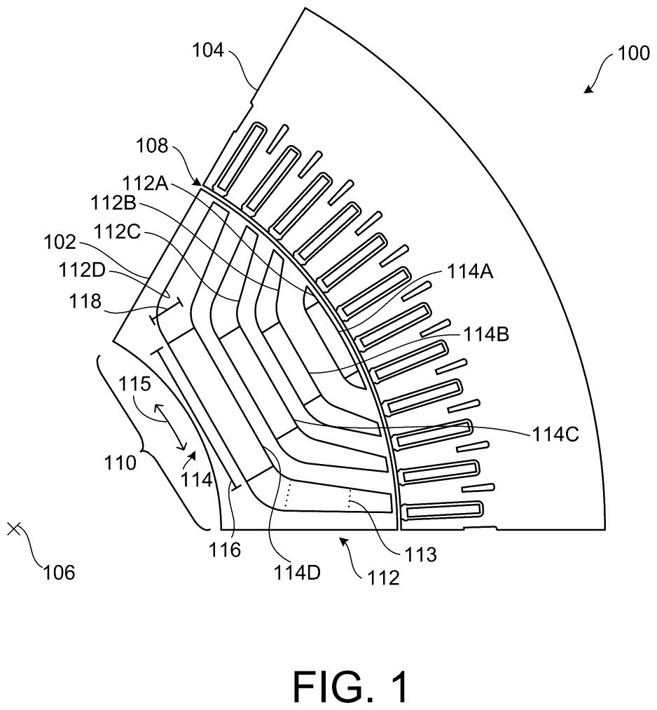

FIG. 1 shows an example of a motor topology 100 that can be used for one pole of a rotor in an electric motor for a vehicle. Here, a portion of a rotor 102 and a portion of a stator 104 are shown. The rotor 102 is configured to rotate about a rotor axis 106, and the motor topology 100 is here shown in an axial view. An air gap 108 is positioned between the rotor 102 and the stator 104. The portion of the rotor 102 shown here corresponds to a pole 110 of the rotor 102, the rotor 102 having multiple poles. The poles 110 can be substantially identically to each other, and only one of the poles 110 is shown for simplicity. The stator 104 has a number of slots for electrical windings. The number of poles of the rotor 102 and the number of slots for the stator 104 are shown for illustrative purposes only. As such, other numbers can be used.

The rotor 102 includes a body that can be formed using a stack of metal laminations. The body defines cavities 112, for example by openings formed between adjacent ribs in the respective rotor laminations, the cavities 112 extending along the direction of the rotor axis 106. The ribs can help create reluctance torque when the motor operates, the reluctance torque being one component of the total torque produced by the motor. The respective shapes of the cavities 112 shown here are illustrative only. In some implementations, one or more bridges 113 can be formed in any or all of the cavities 112 to bridge from one of the ribs to an adjacent rib and thus increase structural rigidity. The bridges 113 can be formed of any of multiple materials, including but not limited to, the metal material of the lamination or a potting material (e.g., a material used for securing permanent magnets in the cavities 112).

The cavities 112 are symmetrically arranged about the rotor axis 106. For example, each of the poles 110 can have a corresponding set of the cavities 112, each of the cavities 112 of the pole 110 being centered about a radius of the rotor 102. Here, four cavities 112 are shown: a cavity 112A is a radially outermost cavity of the cavities 112, and cavities 112B, 112C and 112D are positioned inward of the radially outermost cavity.

Permanent magnets 114 can be placed in some or all of the cavities 112. Here, a RE magnet 114A is positioned in the cavity 112A, and REF magnets 114B, 114C and 114D are positioned in the cavities 112B-112D, respectively. The REF magnets 114B-114D can all be made of a common magnetic material, or at least one of the REF magnets 114B-114D can be made of a different magnetic material.

The motor topology 100 can allow the RE magnet 114A, which is positioned nearest the air gap 108, to shield the REF magnets 114B-114D from demagnetization. As such, in the motor topology 100, a combination of REF magnets and a small amount of RE magnet can be used, wherein a thin layer of the RE magnet can be provided close to the air gap 108 followed by several relatively thicker REF magnets. The presence of the RE magnet can reduce the demagnetization field on the REF magnets.

The equation below is a simplified linear relationship of the magnetic equivalent circuit.

$${H}_{{m}_{i}} = \frac{NI - {\sum }_{j} \frac{{B}_{{r}_{j}} {L}_{{m}_{j}}}{{μ}_{r}}}{( {\sum }_{j} {L}_{{m}_{j}} + \frac{{μ}_{r}}{{μ}_{0}} {L}_{air}} + \frac{{B}_{{r}_{i}}}{{μ}_{r}} ,$$

wherein the index i corresponds to the magnet of interest (e.g., a REF magnet), the index j corresponds to all of the magnets including the RE and REF magnets, Hₘ_{ᵢ} is the field intensity of magnet i, N is the number of turns, I is the current opposing magnetization, Bᵣ_{ᵢ} is the remanence of magnet i, Lₘ_{ⱼ} is the thickness of magnet j, Lₐᵢᵣ is the air gap thickness, M, is the magnet permeability, and μ₀ is the free space permeability.

As such, with a higher remanence in the direction of the demagnetization axis (i.e., Bᵣ_{ⱼ} is greater for the RE magnet), there will be a decrease in the field inside the REF magnets (i.e., Hₘ_{ᵢ} decreases). Bᵣ_{ⱼ} will include the RE magnet which has a higher remanence and in turn reduces the field inside the REF magnet. That is, the presence of the RE magnet shields the REF magnet from demagnetization.

The shape of each of the one or more permanent magnets 114 can be essentially a rectangular prism having six essentially rectangular faces that meet each other at right angles. The largest two of these rectangular faces which are parallel to each other are referred to as the bases of the rectangular prism. The permanent magnet can be positioned so that the bases are perpendicular to the radius of the rotor 102. For example, in each of the permanent magnets 114 one of the bases is here facing directly toward the air gap 108 and the other is facing in the opposite direction toward the rotor axis 106. Some examples described below focus on certain aspects of the shapes of the permanent magnets 114 such as width and thickness without necessarily specifying a length of the magnet (i.e., the dimension of the magnet in the direction perpendicular to the plane of the present drawing). Different lengths can be used. In some implementations, each magnet is approximately as long as the length of the rotor body along the rotor axis 106.

The permanent magnets 114 can have any of a variety of different widths and/or thicknesses. In some implementations, the width of a magnet can be defined to extend perpendicular to the radius of the rotor and tangential to a direction of rotation 115. For example, using such a definition of width, the REF magnet 114D here has a width 116. In some implementations, the respective widths of the REF magnets 114B-114D increase toward the rotor axis 106. For example, the width 116 of the REF magnet 114D which is positioned closest to the rotor axis 106 of the REF magnets 114B-114D is then here the greatest among the widths of the REF magnets 114B-114D. The increasing width creates a flux focusing effect without compromising demagnetization.

In some implementations, the thickness of a magnet can be defined as extending along the radius of the rotor. For example, using such a definition of width, the REF magnet 114D here has a thickness 118. In some implementations, the respective thicknesses of the REF magnets 114B-114D increase toward the rotor axis 106. For example, the thickness 118 of the REF magnet 114D which is positioned closest to the rotor axis 106 of the REF magnets 114B-114D is then here the greatest among the thicknesses of the REF magnets 114B-114D. In other implementations, the respective thicknesses of the REF magnets 114B-114D do not increase toward the rotor axis 106.

The RE magnet 114A can have a greater or smaller width than one or more of the REF magnets 114B-114D. In some implementations, the width of the RE magnet 114A can be about equal to the width of the REF magnet 114B, which is the uppermost REF magnet of the REF magnets 114B-114D. The increasing width can create a flux focusing effect that can increase torque density. That is, a flux barrier can be thicker toward the center of the rotor 102 and decrease at the side that is closer to the air gap 108, which can increase the reluctance component of the produced torque.

The RE magnet 114A can have a greater or smaller thickness than one or more of the REF magnets 114B-114D. In some implementations, the thickness of the RE magnet 114A can be less than the thickness of the REF magnet 114B, which is the uppermost REF magnet of the REF magnets 114B-114D.

Each of the poles 110 can include any number of permanent magnets. As described above, here the pole 110 includes one RE magnet and three REF magnets. Other numbers can be used.

Computer simulations can confirm the validity of the motor topology 100. Computer simulations were performed corresponding to magnet temperatures of 20° C. and 120° C. For example, the latter temperature may be a worst case scenario for RE magnets, and vice versa for the REF magnets. The computer simulations showed a demagnetization coefficient of about one throughout the REF magnets 114B-114D at both temperatures. This result indicates that no demagnetization is occurring. That is, the RE magnet 114A is protecting the REF magnets 114B-114D from demagnetization.

In the motor topology 100, the presence of the RE magnet 114A can be essentially only to protect the underlying layers of REF magnets. The primary torque production of the electric motor having the rotor 102 is from the REF magnets 114B-114D which have the greater mass.

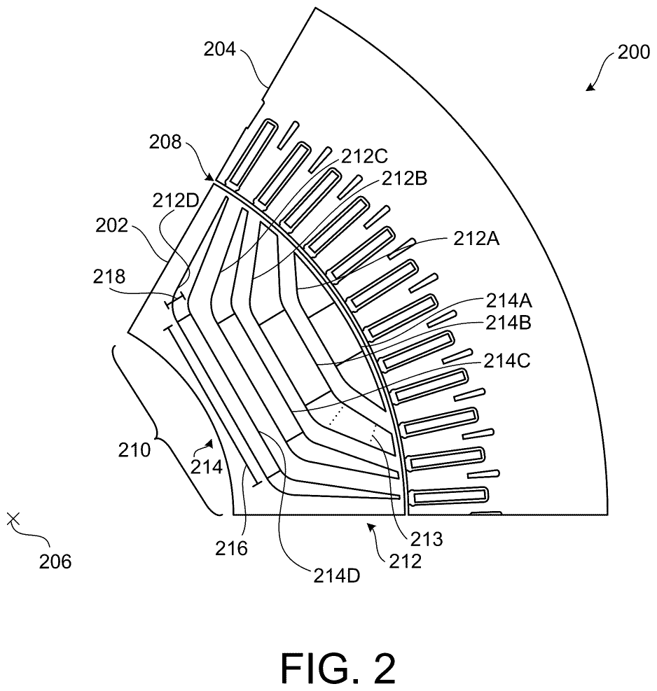

FIG. 2 shows another example of a motor topology 200 that can be used for one pole of a rotor in an electric motor. In analogy with the description above, the motor topology 200 includes a rotor 202, a stator 204, with the rotor 202 configured to rotate about a rotor axis 206, and an air gap 208 between the rotor 202 and the stator 204, with the portion of the rotor 202 shown here corresponding to a pole 210 of the rotor 202, the rotor 202 having multiple poles. The number of poles of the rotor 202 and the number of slots for the stator 204 are shown for illustrative purposes only. As such, other numbers can be used.

The rotor 202 includes a body that defines cavities 212, for example by openings formed between adjacent ribs in the respective rotor laminations, the cavities 212 extending along the direction of the rotor axis 206. The respective shapes of the cavities 212 shown here are illustrative only. In some implementations, one or more bridges 213 can be formed in any or all of the cavities 212 to bridge from one of the ribs to an adjacent rib and thus increase structural rigidity. The bridges 213 can be formed of any of multiple materials, including but not limited to, the metal material of the lamination or a potting material (e.g., a material used for securing permanent magnets in the cavities 212).

The cavities 212 are symmetrically arranged about the rotor axis 206. For example, each of the poles 210 can have a corresponding set of the cavities 212, each of the cavities 212 of the pole 210 being centered about a radius of the rotor 202. Here, four cavities 212 are shown: a cavity 212A is a radially outermost cavity of the cavities 212, and cavities 212B, 212C and 212D are positioned inward of the radially outermost cavity.

Permanent magnets 214 can be placed in some or all of the cavities 212. Here, no RE magnets are being used in the motor topology 200. Rather, the motor topology 200 includes REF magnets 214A, 214B, 214C and 214D positioned in the cavities 212A-212D, respectively. The REF magnets 214A-214D can all be made of a common magnetic material, or at least one of the REF magnets 214A-214D can be made of a different magnetic material.

The shape of each of the REF magnets 214A-214D can be essentially a rectangular prism having six essentially rectangular faces that meet each other at right angles. The largest two of these rectangular faces which are parallel to each other can be referred to as the bases of the rectangular prism. The permanent magnet can be positioned so that the bases are perpendicular to the radius of the rotor 202. For example, in each of the REF magnets 214A-214D one of the bases is here facing directly toward the air gap 208 and the other is facing in the opposite direction toward the rotor axis 206. Some examples described below focus on certain aspects of the shapes of the REF magnets 214A-214D such as width and thickness without necessarily specifying a length of the magnet (i.e., the dimension of the magnet in the direction perpendicular to the plane of the present drawing). Different lengths can be used. In some implementations, each magnet is approximately as long as the length of the rotor body along the rotor axis 206.

The REF magnets 214A-214D can have any of a variety of different widths and/or thicknesses. Here, the REF magnet 214D here has a width 216. In some implementations, the respective widths of the REF magnets 214A-214D increase toward the rotor axis 206. For example, the width 216 of the REF magnet 214D which is positioned closest to the rotor axis 206 of the REF magnets 214A-214D is then here the greatest among the widths of the REF magnets 214A-214D. The increasing width can protect against demagnetization.

Here, the REF magnet 214D has a thickness 218. In some implementations, the respective thicknesses of the REF magnets 214A-214D decrease toward the rotor axis 206. For example, the thickness 218 of the REF magnet 214D which is positioned closest to the rotor axis 206 of the REF magnets 214A-214D is then here the smallest among the thicknesses of the REF magnets 214A-214D. The relatively greater thickness of the REF magnet 214A which is positioned closest to the air gap 208 can then prevent or reduce demagnetization of the REF magnets 214B-214D.

Each of the poles 210 can include any number of permanent magnets. As described above, here the pole 210 includes four REF magnets. Other numbers can be used. As indicated by the equation above, with a greater thickness (i.e., Lₘ_{ⱼ} is greater for the REF magnet 214A), there will be a decrease in the field inside the REF magnets (i.e., Hₘ_{ᵢ} decreases). That is, the thickness of the REF magnet 214A shields the REF magnets 214B-214D from demagnetization.

Computer simulations can confirm the validity of the motor topology 200. A computer simulation was performed corresponding to a magnet temperature of 20° C. which can be considered the worst case scenario for the REF magnets 214A-214D. The computer simulation showed a demagnetization coefficient of about one throughout the REF magnets 214B-214D with only minor demagnetization of the REF magnet 214A on the order of about 1%. That is, the thickness of the REF magnet 214A protects the REF magnets 214B-214D from demagnetization.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A rotor for an electric motor, the rotor comprising:
a body defining cavities, the cavities being symmetrically arranged about a rotor axis in multiple poles;
a rare earth magnet in a radially outermost cavity of the cavities of each of the multiple poles; and
at each of the multiple poles, rare earth free magnets in the cavities positioned inward of the radially outermost cavity, the rare earth free magnets centered on a radius of the rotor.

2. The rotor of claim 1, wherein a shape of the rare earth magnet is essentially a first rectangular prism, and wherein bases of the first rectangular prism are parallel with each other and perpendicular to the radius of the rotor.

3. The rotor of claim 1, wherein a shape of each of the rare earth free magnets is essentially a second rectangular prism, and wherein bases of the second rectangular prism are parallel with each other and perpendicular to the radius of the rotor.

4. The rotor of claim 1, wherein respective widths of the rare earth free magnets perpendicular to the radius of the rotor and tangential to a direction of rotation increase toward the rotor axis.

5. The rotor of claim 1, wherein respective thicknesses of the rare earth free magnets along the radius of the rotor increase toward the rotor axis.

6. The rotor of claim 1, wherein a width of the rare earth magnet perpendicular to the radius of the rotor and tangential to a direction of rotation is about equal to a width of an uppermost rare earth free magnet of the rare earth free magnets perpendicular to the radius of the rotor and tangential to the direction of rotation.

7. The rotor of claim 1, wherein a thickness of the rare earth magnet along the radius of the rotor is less than a thickness of an uppermost rare earth free magnet of the rare earth free magnets along the radius of the rotor.

8. The rotor of claim 1, wherein each pole of the rotor includes the rare earth magnet and three of the rare earth free magnets.

9. The rotor of claim 1, wherein all of the rare earth free magnets are made of a common magnetic material.

10. A rotor for an electric motor, the rotor comprising:
a body defining cavities, the cavities being symmetrically arranged about a rotor axis in multiple poles; and
at each of the multiple poles, rare earth free magnets in the cavities, the rare earth free magnets centered on a radius of the rotor, wherein respective widths of the rare earth free magnets perpendicular to the radius of the rotor and tangential to a direction of rotation increase toward the rotor axis, and wherein respective thicknesses of the rare earth free magnets along the radius of the rotor decrease toward the rotor axis.

11. The rotor of claim 10, wherein a shape of each of the rare earth free magnets is essentially a second rectangular prism, and wherein bases of the second rectangular prism are parallel with each other and perpendicular to the radius of the rotor.

12. The rotor of claim 10, wherein each pole of the rotor includes four rare earth free magnets.

13. The rotor of claim 10, wherein all of the rare earth free magnets are made of a common magnetic material.

14. The rotor of claim 10, wherein the rotor does not include any rare earth magnet.
